(19) United States
(12) Patent Application Publication
(10) Pub. No.: US 2005/0081897 A1
(43) Pub. Date: Apr. 21, 2005

(54) Washing arm for a dish-washing machine

(76) Inventor: Gianluca Pardini, Lucca (IT)

Correspondence Address: THOMPSON HINE LLP, 2000 COURTHOUSE PLAZA N.E., 10 WEST SECOND STREET, DAYTON, OH, 45402-1758, US

(21) Appl. No.: 10/964,025

(22) Filed: Oct. 13, 2004

(30) Foreign Application Priority Data
Oct. 17, 2003 (IT) BO2003A000607

(51) Int. Cl. B08B 3/00

(52) U.S. Cl. 134/58 D

(57) ABSTRACT

A washing arm for a dish-washing machine, made up of: a liquid delivery portion, in which there is made a plurality of holes, through which there comes out the water/detergent mixture and which has a flattened shape having an oblong cross section; and a connection portion, which is cylindrical in shape and is designed to connect to a water supply line of the dish-washing machine.

The present invention relates to a washing arm for a dish-washing machine.

### BACKGROUND OF THE INVENTION

Normally, dish-washing machines used in establishments such as hotels and restaurants comprise washing arms constituted by a pipe with circular cross section, which is set in rotation about one of its axes of symmetry and has a plurality of lateral holes for outflow of the water/detergent mixture.

However, even though the washing arms described above are widely used, they present the drawback of producing a jet of water of a particularly high power only if they are supplied with water at a high pressure.

Furthermore, another drawback of the washing arms of the known art derives from the fact that, given their cylindrical shape, it is impossible to have available two parallel rows of holes for outflow of the water/detergent mixture, unless two parallel arms are provided, with consequent losses of head.

The purpose of the present invention is to provide washing arms for a dish-washing machine, the technical characteristics of which will enable a solution of the disadvantages of the known art to be obtained in a simple and economically advantageous way.

### SUMMARY OF THE INVENTION

The subject of the present invention is a washing arm for a dish-washing machine comprising a liquid delivery portion, in which there is made a plurality of holes through which there comes out the water/detergent mixture and a connection portion designed to connect to a water supply line of the dish-washing machine; said washing arm being characterized in that said liquid delivery portion has a flattened shape presenting an oblong cross section.

According to a preferred embodiment of the present invention, the liquid delivery portion comprises two opposite plane walls, on one of which are made the holes through which there comes out the water/detergent mixture.

### BRIEF DESCRIPTION OF THE DRAWINGS

The example presented in what follows has a purely illustrative and non-limiting purpose, in order to enable a better understanding of the invention, with the aid of the annexed table of drawings, in which:

FIG. 1 is a perspective view of a dish-washing machine, with parts removed, comprising a preferred embodiment of the washing arms according to the present invention;

FIG. 2 is a perspective view, at an enlarged scale, of a washing arm of FIG. 1; and

FIG. 3 is an exploded view of the washing arm of FIG. 2.

### DETAILED DESCRIPTION OF THE INVENTION

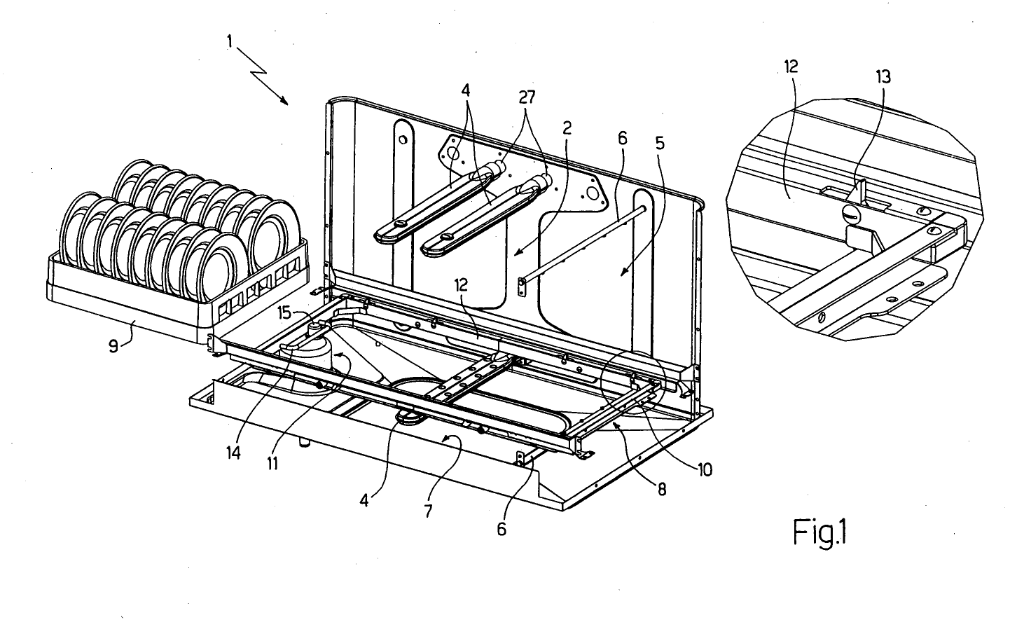

In FIG. 1, designated as a whole by 1 is a dish-washing machine. The dish-washing machine 1 comprises a washing station 2, defined by three washing arms 4, a rinsing station 5, defined by two rinsing arms 6, a tank for collecting the waters 7, and movement means 8 for moving a dish rack 9 at least from the washing station 2 to the rinsing station 5.

The movement means 8 comprise a thrust carriage 10 and an actuation assembly 11 for actuating the thrust carriage 10.

In particular, the thrust carriage 10 comprises a rectangular frame 12, a plurality of engagement teeth 13 hinged to the frame 12, and a handle element 14 fixed to one short side of the frame 12. The actuation assembly 11 comprises a pin 15, which engages the handle element 14 and is moved by a device (known and not illustrated herein) comprising a motor and a motor reducer.

As is known, the engagement of the pin 15 with the handle element 14 enables transformation of the circular motion of the pin 15 itself into a reciprocating translational motion of the thrust carriage 10.

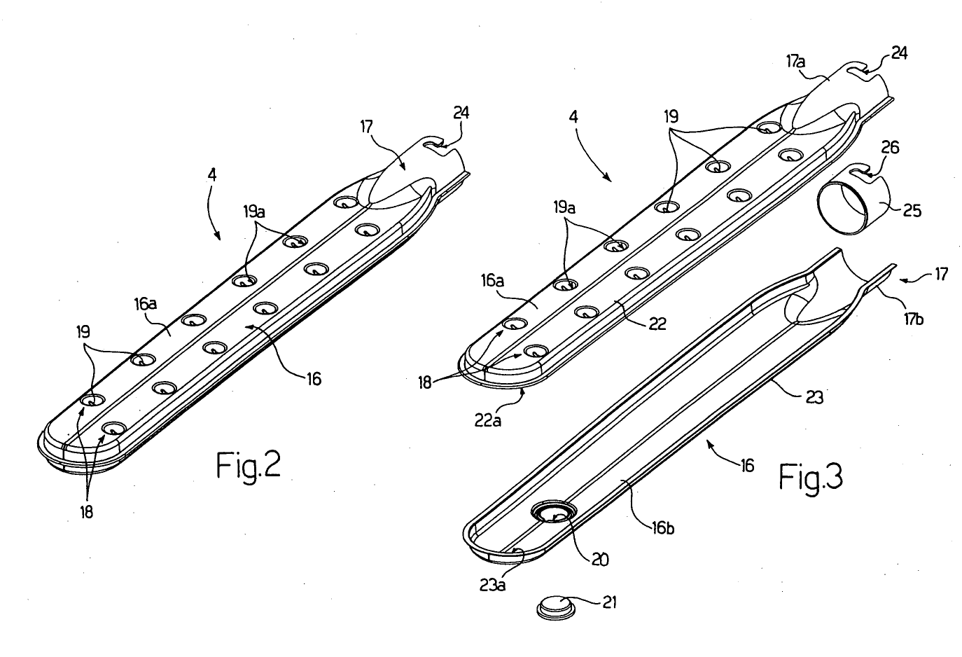

As illustrated in FIGS. 2 and 3, each of the washing arms 4 comprises a liquid delivery portion 16 having a flattened shape presenting an oblong cross section, and a cylindrical connection portion 17.

The liquid delivery portion 16 comprises two slightly convex opposite walls 16a and 16b. Made in the wall 16a are two parallel and longitudinal rows 18 of holes 19 arranged in mutually staggered positions, whilst in the wall 16b there is made a discharge hole 20 equipped with a corresponding plug 21.

Each of the holes 19, through which the water/detergent mixture is delivered, has an oblong shape, to ensure a given power of the jet, and is made at the centre of a circular concavity 19a. Said concavity has the purpose of guaranteeing an effective shape of the jet of the water/detergent mixture and, at the same time, of preventing the holes 19 from being obstructed by deposits of dirt due to the recirculation of the aforesaid washing mixture during the washing operation itself.

The hole 20 has the purpose of discharging the water/detergent mixture that has remained in the washing arm, and in any case represents a point of access for maintenance operations inside the washing arm.

In particular, as illustrated in FIG. 3, each of the washing arms 4 is made up of two parts 22 and 23, coupled together to form the washing arm 4 itself. Each of the parts 22 and 23 constitutes a longitudinal half of the arm 4 and comprises a respective wall 16a and 16b.

The two parts 22 and 23 are coupled together by means of a mechanism for fitting in their respective edges 22a and 23a.

Each of the two parts 22 and 23 comprises a respective half 17a and 17b defining two semi-cylindrical walls of the cylindrical connection portion 17. In the half 17a there is made an L-shaped slot 24, which has the purpose of fixing the washing arm 4, by means of a bayonet mechanism, to attachment means 27 indicated in FIG. 1. The bayonet mechanism has proven the most effective for guaranteeing a tightness of the washing arm 4 against the pressure of fluid that is created within the washing arm 4 itself.

For purposes of reinforcement, the connection portion 17 comprises a sleeve 25, which is housed within the two halves 17a and 17b and in which a slot 26 is made that is the same as the slot 24, with which, in use, it mates to enable the aforesaid bayonet mechanism.

The washing arm of the present invention makes available a high-power jet of the water/detergent mixture even without using large amounts of water, thus guaranteeing efficient washing operation.

1. A washing arm (4) for a dish-washing machine (1), comprising a liquid delivery portion (16), in which there is made a plurality of holes (19), through which there comes out a water/detergent mixture, and a connection portion (17), designed to connect to a water supply line of the dish-washing machine (1); said washing arm (4) being characterized in that said liquid delivery portion (16) has a flattened shape presenting an oblong cross section.

2. The washing arm according to claim 1, characterized in that it is made up of two parts (22, 23) coupled together, each of said two parts (22, 23) constituting a longitudinal half of the element (4).

3. The washing arm according to claim 1, characterized in that said liquid delivery portion (16) comprises two opposite walls (16a, 16b), in one (16a) of said walls there being made two rows (18) of parallel holes (19), arranged in mutually staggered positions.

4. The washing arm according to claim 3, characterized in that each of said holes (19) has an oblong shape.

5. The washing arm according to claim 4, characterized in that each of said holes (19) is made at the centre of a concave circular portion (19a).

6. The washing arm according to claim 3, characterized in that it presents a discharge hole (20) equipped with a corresponding removable closing element (21), said discharge hole (20) being made in said wall (16b).

7. The washing arm according to claim 1, characterized in that it comprises a connection portion (17) of a cylindrical shape, which is adjacent to said liquid delivery portion (16) and is designed to connect to attachment means (27) of said dish-washing machine (1).

8. The washing arm according to claim 7, characterized in that made in a wall (17a) of said connection portion (17) is an L-shaped slot (24) to enable a mechanism of bayonet connection between the washing arm (4) and said connection means (27).

9. The washing arm according to claim 8, characterized in that said connection portion (17) comprises an internal reinforcement sleeve (25), in which there is made a slot (26) that is the same as said slot (24).

10. A dish-washing machine, characterized in that it uses a washing arm (4) according to claim 1.
